(19) United States
(12) Patent Application Publication
(10) Pub. No.: US 2026/0367022 A1
(43) Pub. Date: Nov. 19, 2026

(54) X-RAY PHOTOELECTRON SPECTROMETER

(71) Applicant: SHIMADZU CORPORATION, Kyoto-shi (JP)

(72) Inventor: Tatsuya NISHIO, Kyoto-shi (JP)

(21) Appl. No.: 19/656,721

(22) Filed: Apr. 23, 2026

(30) Foreign Application Priority Data
May 13, 2025 (JP) 2025-080441

(51) Int. Cl. G01N 23/2273; G01N 23/04; G06T 7/70

(52) U.S. Cl. CPC G01N 23/2273; G01N 23/04; G06T 7/70; G01N 2223/1016; G01N 2223/303; G01N 2223/309; G01N 2223/321; G01N 2223/401; G06T 2207/30204

(57) ABSTRACT

In an XPS, a controller causes a camera to capture an image. The controller identifies a positional relationship between an analysis point on a sample holder and markers (elements) in the image captured by the camera. Then, the controller controls a drive source such that the analysis point is placed at an X-ray irradiation position based on the identified positional relationship.

### TECHNICAL FIELD

The present invention relates to an X-ray photoelectron spectrometer, and particularly to alignment between an analysis point and an X-ray irradiation position of an X-ray source.

### BACKGROUND ART

Surface analysis is an analysis that clarifies the structure and composition of a surface (or interface) of a sample by applying a stimulus to the sample and analyzing the detected response. As an apparatus for surface analysis, for example, there is an X-ray Photoelectron Spectrometer (XPS: X-ray Imaging Photoelectron Spectrometer) as disclosed in Japanese Patent Laying-Open No. 2001-153760 (Patent Document 1).

An XPS has an analysis chamber for performing analysis and a sample exchange chamber where a user performs sample exchange. The analysis chamber and the sample exchange chamber are usually evacuated, and they are separated by a gate valve. The user places a sample holder carrying a sample on a holding fork in the sample exchange chamber. Thereafter, an arm transfers the holding fork to the analysis chamber, whereby the sample holder placed on the holding fork is transferred to the analysis chamber.

The user designates an analysis point on the sample holder with respect to an image captured in the sample exchange chamber. In the analysis chamber, the position of the sample holder is adjusted such that the designated analysis point is located at the irradiation position of the X-ray source. Thereafter, X-rays are irradiated, and an analysis result is derived.

### SUMMARY OF INVENTION

### Technical Problem

In order to place the analysis point at the X-ray irradiation position, an element on the sample holder (for example, a screw for fixing the sample holder) has been used. More specifically, when an analysis point is designated in the image captured in the sample exchange chamber, the positional relationship between the analysis point and the element in the image is identified. Under the assumption that the positional relationship between the arm and the sample holder is constant, in the analysis chamber, the arm is driven such that the analysis point is placed at the X-ray irradiation position based on the positional relationship between the analysis point and the element.

However, there have been cases where the positional relationship between the arm and the sample holder is not constant, such as when a deviation occurs in the setting position of the sample holder on the holding fork. For this reason, there has been a demand for a technique for accurately irradiating X-rays onto an analysis point desired by a user.

The present invention has been conceived in view of such circumstances, and an object thereof is to provide a technique for accurately irradiating X-rays onto an analysis point desired by a user.

### Solution to Problem

An X-ray photoelectron spectrometer according to an aspect of the present disclosure includes: a sample exchange chamber configured to accommodate a sample holder; an imaging unit configured to capture an image of an inside of the sample exchange chamber; an analysis chamber; an X-ray source configured to irradiate the analysis chamber with X-rays; an arm for transferring the sample holder from the sample exchange chamber to the analysis chamber; and a drive source configured to drive the arm. The arm has a marker. The X-ray photoelectron spectrometer includes a controller configured to control the drive source such that an analysis point is placed at an irradiation position of the X-rays based on a positional relationship between the analysis point on the sample holder and the marker in the image captured by the imaging unit.

### Advantageous Effects of Invention

According to an aspect of the present disclosure, a technique for accurately irradiating X-rays onto an analysis point desired by a user is provided.

### BRIEF DESCRIPTION OF DRAWINGS

FIG. 1 is a diagram showing a configuration of an XPS 1 according to an embodiment.

FIG. 2 is a diagram showing an example of a state where a sample holder 90 is placed on an arm 22.

FIG. 3 is a flowchart of calibration processing of the XPS 1.

FIG. 4 is a flowchart of processing for analyzing a sample.

### DESCRIPTION OF EMBODIMENTS

Hereinafter, embodiments of the present disclosure will be described in detail with reference to the drawings. In the drawings, the same or corresponding parts are denoted by the same reference signs, and the description thereof will not be repeated.

### Configuration of X-ray Photoelectron Spectrometer

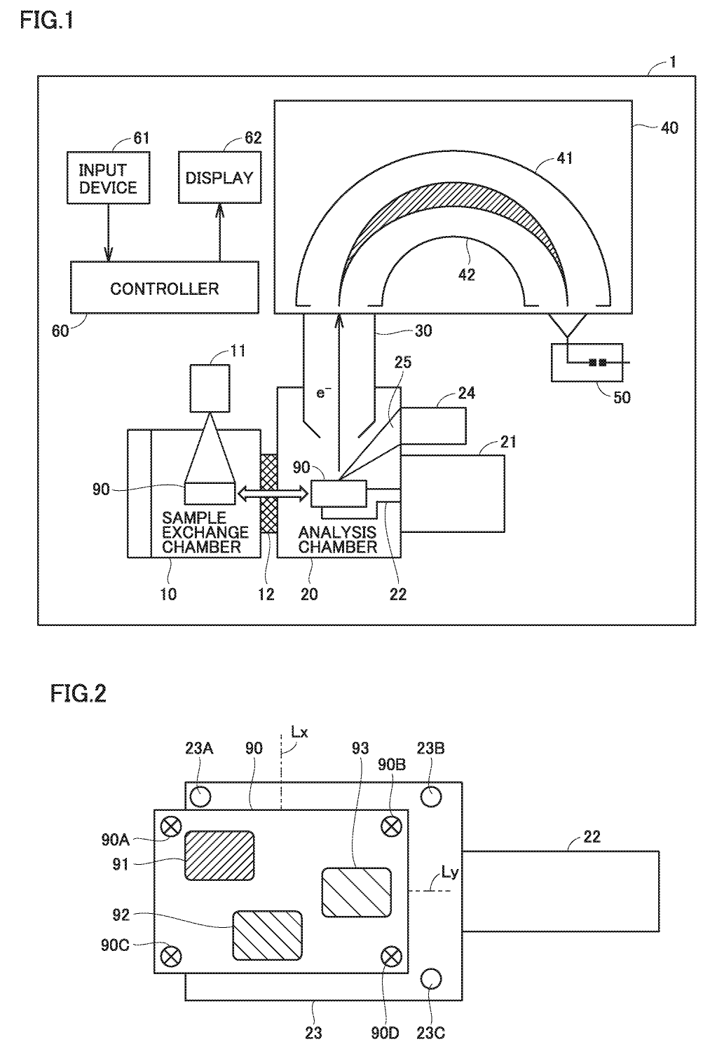

FIG. 1 is a diagram showing a configuration of an XPS 1 according to an embodiment. The XPS 1 measures a kinetic energy distribution of photoelectrons emitted by irradiating a sample with X-rays, and acquires information regarding the types, abundance, and chemical bonding states of elements present on the surface of the sample.

Referring to FIG. 1, the XPS 1 includes a sample exchange chamber 10, an analysis chamber 20, a lens 30, an energy analyzer 40, a detector 50, and a controller 60. The sample exchange chamber 10 and the analysis chamber 20 are usually evacuated.

The analysis chamber 20 is provided with a drive source 21 and an arm 22. The arm 22 moves back and forth between the sample exchange chamber 10 and the analysis chamber 20 as indicated by a double-headed arrow in FIG. 1 by being driven by the drive source 21. FIG. 1 shows a state where the arm 22 is located in the analysis chamber 20. A gate valve 12 is provided at a boundary between the sample exchange chamber 10 and the analysis chamber 20. The gate valve 12 is usually closed. When the arm 22 moves from the sample exchange chamber 10 to the analysis chamber 20, and when moving from the analysis chamber 20 to the sample exchange chamber 10, the gate valve 12 is opened. When the movement is completed, the gate valve 12 is closed.

The sample exchange chamber 10 is provided with a camera 11 (an example of an imaging unit). A user sets a sample holder 90 on which one or more types of samples are placed at a given position (for example, a sample chamber fork, not shown) in the sample exchange chamber 10. The arm 22 is driven to move to the sample exchange chamber 10. In the sample exchange chamber 10, the arm 22 is driven such that the sample holder 90 moves from the sample chamber fork onto a fork of the arm 22. In the sample exchange chamber 10, an image of the sample holder 90 placed on the fork of the arm 22 is captured by the camera 11. Thereafter, the sample holder 90 is transferred to the analysis chamber 20 as the arm 22 moves from the sample exchange chamber 10 to the analysis chamber 20.

The analysis chamber 20 is provided with an X-ray source 24. When X-rays 25 are irradiated from the X-ray source 24 toward the sample holder 90, electrons are emitted from the sample at the irradiation position of the X-rays 25.

The lens 30 receives electrons emitted from the sample, decelerates the electrons, and focuses them. Although omitted in FIG. 1, a slit is provided between the lens 30 and the energy analyzer 40. The lens 30 includes, for example, an electrostatic lens and a retarding lens. The electrostatic lens focuses electrons onto an entrance of the slit. The retarding lens decelerates electrons entering the energy analyzer 40.

The energy analyzer 40 spatially separates two or more electrons according to the kinetic energy of each of the two or more electrons emitted from the sample. The energy analyzer 40 includes an outer hemisphere electrode 41 and an inner hemisphere electrode 42. The energy analyzer 40 applies a voltage to the outer hemisphere electrode 41 and the inner hemisphere electrode 42 to generate an electric field between the outer hemisphere electrode 41 and the inner hemisphere electrode 42. The electric field bends the flight path of the electrons that have passed through the slit. The electrons that have passed through the energy analyzer 40 enter the detector 50. The potential difference between the outer hemisphere electrode 41 and the inner hemisphere electrode 42 corresponds to the kinetic energy of electrons that can pass through the energy analyzer 40. In FIG. 1, the energy analyzer 40 is an electrostatic hemispherical electron energy analyzer, but the energy analyzer 40 is not limited to an electrostatic hemispherical electron energy analyzer as long as it controls the flight path of electrons according to the kinetic energy of incident electrons.

The detector 50 detects electrons that have passed through the energy analyzer 40. By adjusting the potential difference between the outer hemisphere electrode 41 and the inner hemisphere electrode 42, the kinetic energy of electrons capable of passing through the energy analyzer 40 changes.

The controller 60 generates an analysis result of the sample based on the detection result of the detector 50. In one implementation example, the controller 60 includes a processor such as a CPU (Central Processing Unit) and a non-volatile memory. In the controller 60, various functions are realized by the processor executing a given program. Note that a dedicated circuit such as an ASIC (application specific integrated circuit) or an FPGA (field-programmable gate array) may be included instead of the processor or in addition to the processor, and information management processing may be executed as a function of the dedicated circuit.

The controller 60 controls operations of elements of the XPS 1 (the camera 11, the drive source 21, the X-ray source 24, and the like). The XPS 1 further includes an input device 61 and a display 62. The input device 61 is, for example, a keyboard and/or a mouse. The input device 61 accepts an operation from a user and transmits the content of the operation to the controller 60. The display 62 displays information in accordance with instructions from the controller 60.

### Markers on Arm

FIG. 2 is a diagram showing an example of a state where the sample holder 90 is placed on the arm 22. In FIG. 2, a fork portion at the tip of the arm 22 is shown as a fork portion 23. The sample holder 90 is placed on the fork portion 23.

Three types of samples 91, 92, and 93 are placed on the sample holder 90. The sample holder 90 is provided with four screws 90A, 90B, 90C, and 90D. On the other hand, the fork portion 23 is provided with three elements 23A, 23B, and 23C.

In the XPS 1, as described above, the user designates an analysis point on the sample holder 90 with respect to the image captured in the sample exchange chamber 10. In the analysis chamber 20, the arm 22 is driven such that the designated analysis point is located at the X-ray irradiation position of the X-ray source 24.

In order to identify the absolute position of the designated analysis point, it is conceivable to use the screws 90A to 90D provided on the sample holder 90. More specifically, when an analysis point is designated in the image captured in the sample exchange chamber 10, the positional relationship between the analysis point in the image and the screws 90A to 90D is identified. Under the assumption that the positional relationship between the arm 22 and the sample holder 90 is constant, in the analysis chamber 20, the arm 22 is driven such that the analysis point is placed at the X-ray irradiation position based on the positional relationship between the analysis point and the screws 90A to 90D.

However, when a positional deviation occurs between the arm 22 and the sample holder 90, such as when a deviation occurs in the installation position of the sample holder 90 on the fork portion 23, there may be a concern that the analysis point is not accurately placed at the X-ray irradiation position.

For this reason, in order to accurately place the X-ray irradiation position at the analysis point in the analysis chamber 20, the user was required to capture an image also in the analysis chamber 20 in order to recognize the positions of the screws 90A to 90D for each analysis. For an image in the analysis chamber 20, the user is required to install an additional camera in the analysis chamber 20 or to capture an X-ray image.

On the other hand, in the XPS 1, the elements 23A, 23B, and 23C on the arm 22 are used as markers in order to identify the absolute position of the designated analysis point. More specifically, a positional relationship between the analysis point in the image captured in the sample exchange chamber 10 and the elements 23A, 23B, and 23C on the arm 22 is identified, and based on the positional relationship, the arm 22 is driven such that the analysis point is placed at the X-ray irradiation position. Thereby, even if a deviation occurs in the installation position of the sample holder 90 on the fork portion 23, a situation where the analysis point is not accurately placed at the X-ray irradiation position due to this does not occur. Here, it is premised that the positional relationship between the sample holder 90 and the fork portion 23 does not change during sample transfer.

In the XPS 1, the marker has a plurality of elements (element 23A, element 23B, element 23C). Note that the marker may have at least one element. However, when the marker has a plurality of elements as shown in FIG. 2, when identifying the positional relationship between the analysis point and the marker, the positional relationship between the analysis point and each of the plurality of elements (in the example of FIG. 2, three types of positional relationships (marker and element 23A, marker and element 23B, marker and element 23C)) can be used, whereby the absolute position of the analysis point can be identified more accurately.

It is preferable that the plurality of elements of the marker be arranged in a dispersed manner with respect to the sample holder 90. In FIG. 2, a line Lx represents the center of the sample holder 90 in the left-right direction (an example of a first direction), and a line Ly represents the center of the sample holder 90 in the up-down direction (an example of a second direction). "Dispersed" will be described with reference to the line Lx and the line Ly. That is, the element 23A is located on one side of the line Lx, and the element 23B and the element 23C are located on the other side of the line Lx. Further, the element 23A and the element 23B are located on one side of the line Ly, and the element 23C is located on the other side of the line Ly. By using the plurality of elements arranged in a dispersed manner with respect to the sample holder 90 as markers, the absolute position of the analysis point on the sample holder 90 can be identified more accurately.

The elements 23A, 23B, and 23C are preferably composed of a relatively stable substance, such as gold, for example. Thereby, a situation where the reliability in identifying the positions of the elements 23A, 23B, and 23C decreases due to the influence of surface oxides is avoided, and a situation where the evacuated analysis chamber 20 is contaminated by contaminants such as oxides of the elements 23A, 23B, and 23C can be avoided. Note that when the marker (element) is composed of a relatively stable substance, even if the marker (element) is arranged at a place other than the arm (for example, on the sample holder 90), the effect that contamination of the analysis chamber 20 is avoided can be expected compared to the conventional case.

Further, since the elements 23A, 23B, and 23C are composed of a substance such as gold having a relatively high intensity of characteristic X-rays, they can be identified in a photoelectron image (a two-dimensional image representing the generation amount of photoelectrons emitted by the photoelectric effect due to X-ray irradiation), whereby there is no need to install a new camera in the analysis chamber 20 even when identifying the positions of the elements 23A, 23B, and 23C in the analysis chamber 20 in calibration.

### Calibration

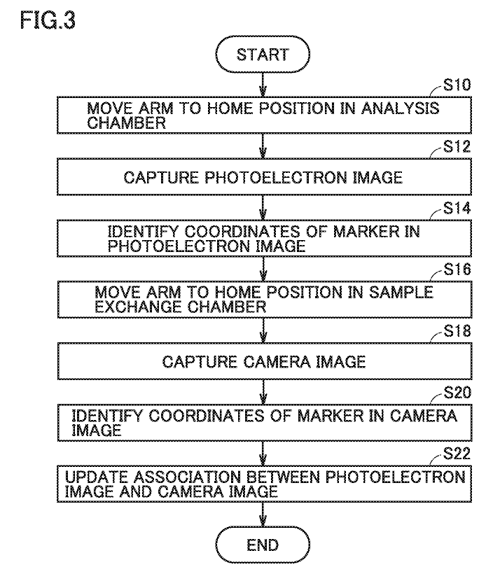

FIG. 3 is a flowchart of calibration processing of the XPS 1. In one implementation example, the functions realized by the processing of FIG. 3 are realized by the processor of the controller 60 executing a given program. The contents of the calibration processing will be described with reference to FIG. 3. In one implementation example, the controller 60 starts the processing of FIG. 3 in response to an operation for instructing calibration being performed on the input device 61.

In step S10, the controller 60 moves the arm 22 to a home position in the analysis chamber 20. In one implementation example, the home position in the analysis chamber 20 is a reference position when moving the sample holder 90 to the X-ray irradiation position.

In step S12, the controller 60 captures a photoelectron image of the arm 22.

In step S14, the controller 60 identifies the position of the marker in the photoelectron image captured in step S12, that is, the coordinates of each of the elements 23A, 23B, and 23C.

In step S16, the controller 60 moves the arm 22 to a home position in the sample exchange chamber 10. In one implementation example, the home position in the sample exchange chamber 10 is a reference position when capturing an image of the sample holder 90 with the camera 11.

In step S18, the controller 60 causes the camera 11 to capture an image of the arm 22.

In step S20, the controller 60 identifies the position of the marker in the image captured in step S18, that is, the coordinates of each of the elements 23A, 23B, and 23C.

In step S22, the controller 60 updates the association of coordinates between the photoelectron image and the camera image in the controller 60 so as to associate the coordinates identified in step S14 with the coordinates identified in step S20. When coordinates of three points are identified in step S14 and coordinates of three points are identified in step S20, the association of coordinates between the photoelectron image and the camera image may be updated to represent a function that associates the center point of the coordinates of the three points identified in step S14 with the center point of the coordinates of the three points identified in step S20.

Thereafter, the controller 60 ends the processing of FIG. 3.

### Analysis

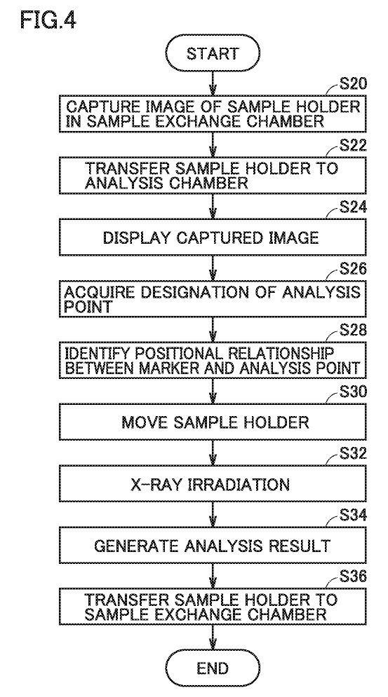

FIG. 4 is a flowchart of processing for analyzing a sample. In one implementation example, the functions realized by the processing of FIG. 4 are realized by the processor of the controller 60 executing a given program. The contents of the analysis processing will be described with reference to FIG. 4. In one implementation example, after setting the sample holder 90 on the sample chamber fork in the sample exchange chamber 10, the user inputs an instruction for analysis to the input device 61. The controller 60 starts the processing of FIG. 4 in response to the instruction for analysis being input to the input device 61.

In step S20, the controller 60 drives the arm 22 such that the sample holder 90 moves from the sample chamber fork to the fork portion 23 of the arm 22, and then captures an image of the sample holder 90 in the sample exchange chamber 10 with the camera 11.

In step S22, the controller 60 drives the arm 22 to transfer the sample holder 90 to the analysis chamber 20.

In step S24, the controller 60 displays the image captured in step S20 on the display 62. In response to the display of the captured image, the user uses the input device 61 to input a designation of an analysis point on the image to the controller 60.

In step S26, the controller 60 acquires the designation of the input analysis point. In one implementation example, the captured image is developed on an xy plane, and the analysis point is designated as coordinates on the xy plane.

In step S28, the controller 60 identifies a positional relationship between the marker on the captured image and the analysis point. In one implementation example, the positional relationship is identified as a difference between each of the x-coordinate and the y-coordinate on the xy plane. When the marker includes a plurality of elements, the positional relationship may be identified as an average value of differences in coordinates between each element and the analysis point.

In step S30, the controller 60 moves the sample holder 90 by driving the arm 22 such that the analysis point is located at the X-ray irradiation position of the X-ray source 24. In one implementation example, the controller 60 identifies the driving amount of the arm 22 in step S30 based on the positional relationship between the marker on the captured image and the analysis point, and the (latest) association of coordinates between the photoelectron image and the camera image.

More specifically, the controller 60 converts a position (pixel position) in the image designated by the user into coordinate information based on the home position of the arm 22, and drives the arm 22 by a driving amount for realizing the coordinate information.

In step S32, the controller 60 causes the X-ray source 24 to output X-rays.

In step S34, the controller 60 uses the detection result of the detector 50 to generate an analysis result of the sample (analysis point). The controller 60 may display the analysis result on the display 62 or store it in a memory in the controller 60.

In step S36, the controller 60 transfers the sample holder 90 to the sample exchange chamber 10. At this time, the controller 60 may notify the end of the analysis (for example, display and/or audio output). Thereafter, the controller 60 ends the processing of FIG. 4. Note that in step S36, the sample holder 90 may be transferred to a place other than the sample exchange chamber 10.

### Aspects

It will be understood by those skilled in the art that the plurality of exemplary embodiments described above are specific examples of the following aspects.

(Item 1) An X-ray photoelectron spectrometer according to one aspect may include a sample exchange chamber configured to accommodate a sample holder, an imaging unit configured to capture an image of an inside of the sample exchange chamber, an analysis chamber, an X-ray source configured to irradiate the analysis chamber with X-rays, an arm for transferring the sample holder from the sample exchange chamber to the analysis chamber, and a drive source configured to drive the arm, wherein the arm has a marker, and the X-ray photoelectron spectrometer includes a controller configured to control the drive source such that an analysis point is placed at an irradiation position of the X-rays based on a positional relationship between the analysis point on the sample holder and the marker in the image captured by the imaging unit.

According to the X-ray photoelectron spectrometer described in Item 1, a technique for accurately irradiating X-rays onto an analysis point desired by a user is provided.

(Item 2) In the X-ray photoelectron spectrometer according to Item 1, the marker may have a plurality of elements.

According to the X-ray photoelectron spectrometer described in Item 2, the positional relationship between the analysis point and the marker can be identified more accurately.

(Item 3) In the X-ray photoelectron spectrometer according to Item 2, the plurality of elements may include a first element arranged on one side with respect to the center of the sample holder on the arm, and a second element arranged on the other side with respect to the center of the sample holder.

According to the X-ray photoelectron spectrometer described in Item 3, the positional relationship between the analysis point and the marker can be identified more accurately.

(Item 4) In the X-ray photoelectron spectrometer according to Item 2, the plurality of elements may include a first element arranged on one side of a first direction and a second direction intersecting the first direction with respect to the center of the sample holder on the arm, a second element arranged on the other side of the first direction with respect to the center of the sample holder, and a third element arranged on the other side of the second direction.

According to the X-ray photoelectron spectrometer described in Item 4, the positional relationship between the analysis point and the marker can be identified more accurately.

(Item 5) In the X-ray photoelectron spectrometer according to any one of Items 1 to 4, the controller may be configured to correct a home position of the arm in the analysis chamber based on a position of the marker in a photoelectron image of the arm using X-rays irradiated from the X-ray source.

According to the X-ray photoelectron spectrometer described in Item 5, the home position of the arm in the analysis chamber can be corrected without providing a new imaging unit in the analysis chamber.

(Item 6) In the X-ray photoelectron spectrometer according to any one of Items 1 to 4, the marker may be composed of gold.

According to the X-ray photoelectron spectrometer described in Item 6, contamination of the analysis chamber and contamination and oxidation of the surface of the marker are avoided as much as possible, and the correction amount can be identified without providing a new imaging unit in the analysis chamber.

It should be considered that the embodiments disclosed this time are illustrative in all respects and not restrictive. The scope of the present disclosure is indicated by the claims rather than the description of the embodiments described above, and it is intended that all changes within the meaning and scope equivalent to the claims are included. Further, it is intended that each technique in the embodiments can be implemented alone or in combination with other techniques in the embodiments as much as possible as necessary.

1. An X-ray photoelectron spectrometer comprising:
a sample exchange chamber configured to accommodate a sample holder;
an imaging unit configured to capture an image of an inside of the sample exchange chamber;
an analysis chamber;
an X-ray source configured to irradiate the analysis chamber with X-rays;
an arm for transferring the sample holder from the sample exchange chamber to the analysis chamber;
a drive source configured to drive the arm; and
a controller,
wherein the arm has a marker, and
the controller is configured to control the drive source such that an analysis point is placed at an irradiation position of the X-rays based on a positional relationship between the analysis point on the sample holder and the marker in the image captured by the imaging unit.

2. The X-ray photoelectron spectrometer according to claim 1, wherein the marker has a plurality of elements.

3. The X-ray photoelectron spectrometer according to claim 2, wherein the plurality of elements includes a first element arranged on one side with respect to a center of the sample holder on the arm, and a second element arranged on the other side with respect to the center of the sample holder.

4. The X-ray photoelectron spectrometer according to claim 2, wherein the plurality of elements includes a first element arranged on one side of a first direction and a second direction intersecting the first direction with respect to a center of the sample holder on the arm, a second element arranged on the other side of the first direction with respect to the center of the sample holder, and a third element arranged on the other side of the second direction.

5. The X-ray photoelectron spectrometer according to claim 1, wherein the controller is configured to correct a home position of the arm in the analysis chamber based on a position of the marker in a photoelectron image of the arm using X-rays irradiated from the X-ray source.

6. The X-ray photoelectron spectrometer according to claim 1, wherein the marker is composed of gold.
